(19) United States
(12) Patent Application Publication
(10) Pub. No.: US 2005/0060226 A1
(43) Pub. Date: Mar. 17, 2005

(54) Recommending an offering based on inventory data

(75) Inventors: Daniel Joseph Heithoff, Rochester, MN (US); R. Kent Holcomb, Indianapolis, IN (US); Satheesh Kumar Krishnamoorthy, Rochester, MN (US); David A. Nusbaum, Rochester, MN (US); Van Dee Sammons, Marietta, GA (US); Kurt Clifford Thompson, Rochester, MN (US); Paul William Wertzler, Rochester, MN (US); Michael William Wiley, Carmel, IN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/660,160

(22) Filed: Sep. 11, 2003

(51) Int. Cl. G06F 17/60

(52) U.S. Cl. 705/14

(57) ABSTRACT

A method, apparatus, system, and signal-bearing medium that in an embodiment recommend an offering to a client based on inventory data received from a client, a condition, and a threshold. The client provides the inventory data, which in various embodiments may be an inventory of hardware and/or software installed at the client and/or an inventory of data that describes performance characteristics and/or a trend of the client. In this way, an offering, such as an offer to provide goods or services, can be targeted to the client based on the specific needs of the client.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention generally relates to computers and more specifically relates to recommending an offering for a computer based on an inventory of the computer.

### BACKGROUND

In the past, companies widely marketed their products indiscriminately via such techniques as billboards, radio, and television. Unfortunately, for some products much of the money spent on this type of marketing was wasted because many recipients (the viewers or listeners) of the marketing might have no interest or need for the products being advertised. This waste of marketing dollars is especially a problem for special-interest or expensive products that might be purchased by only a small segment of the population.

In an attempt to address this problem, companies have attempted to target their marketing to those specific consumers who might be more likely to need the products. For example, companies have attempted to determine as much information as possible about potential consumers, such as their zip code, income, occupation, previous purchases, spending habits, and Internet browsing habits. The companies then used this collected information to more directly target their marketing toward those consumers who are most likely to purchase the marketed products. This targeted marketing has taken the form of coupons, email, direct mail, web page advertisements, and/or telemarketing.

Unfortunately this targeted marketing is still based on limited information, which means that much of the marketing expense is still wasted on consumers who have no need for or no interest in the marketed products. Without a better way to target potential customers who have a real need for a product, companies will continue to waste their marketing dollars.

### SUMMARY

A method, apparatus, system, and signal-bearing medium are provided that in an embodiment recommend an offering to a client based on inventory data received from a client, a condition, and a threshold. The client provides the inventory data, which in various embodiments may be an inventory of hardware and/or software installed at the client and/or an inventory of data that describes performance characteristics and/or trends of the client. In this way, an offering, such as an offer to provide goods or services, can be targeted to the client based on the specific needs of the client.

### BRIEF DESCRIPTION OF THE DRAWINGS

FIG. 1 depicts a block diagram of an example system for implementing an embodiment of the invention.

FIG. 2 depicts a block diagram of an example inventory data structure, according to an embodiment of the invention.

FIG. 3 depicts a block diagram of example triggers, according to an embodiment of the invention.

FIG. 4A depicts a pictorial representation of an example user interface, according to an embodiment of the invention.

FIG. 4B depicts a pictorial representation of an example user interface, according to an embodiment of the invention.

FIG. 4C depicts a pictorial representation of an example user interface, according to an embodiment of the invention.

FIG. 5 depicts a flowchart of example processing, according to an embodiment of the invention.

### DETAILED DESCRIPTION

Embodiments of the invention use for marketing purposes the ability of a client electronic device to collect an inventory of the hardware and software characteristics and performance data of the client electronic device. A server may use this collected data to select goods and/or services for which the client electronic device has a specific need. The server then offers the goods and/or services to the client.

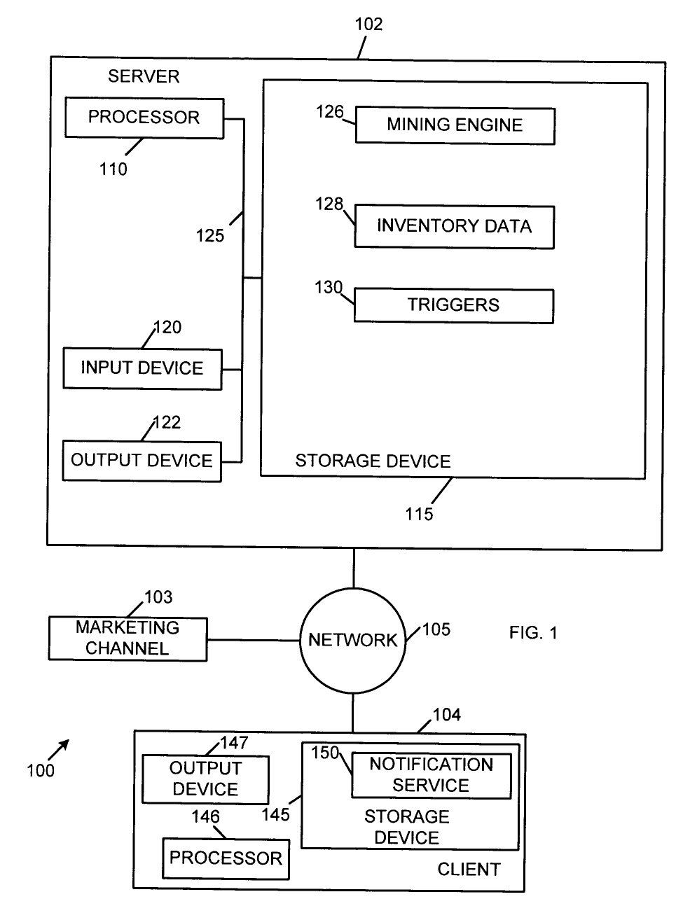

FIG. 1 depicts a block diagram of an example system 100 for implementing an embodiment of the invention. The system 100 includes a server 102 connected to a marketing channel 103 and a client 104 via a network 105. Although only one server 102, one marketing channel 103, one client 104, and one network 105 are shown, in other embodiments any number or combination of them may be present.

The server 102 includes a processor 110, a storage device 1 15, an input device 120, and an output device 122, all connected directly or indirectly via a bus 125. The processor 110 represents a central processing unit of any type of architecture, such as a CISC (Complex Instruction Set Computing), RISC (Reduced Instruction Set Computing), VLIW (Very Long Instruction Word), or a hybrid architecture, although in other embodiments any appropriate processor may be used. The processor 110 executes instructions and includes that portion of the server 102 that controls the operation of the entire server. Although not depicted in FIG. 1, the processor 110 typically includes a control unit that organizes data and program storage in memory and transfers data and other information between the various parts of the server 102. The processor 110 reads and/or writes code and data to/from the storage device 115, the network 105, the input device 120, and/or the output device 122.

Although the server 102 is shown to contain only a single processor 110 and a single bus 125, embodiments of the present invention apply equally to servers that may have multiple processors and multiple buses with some or all performing different functions in different ways.

The storage device 115 represents one or more mechanisms for storing data. For example, the storage device 115 may include read only memory (ROM), random access memory (RAM), magnetic disk storage media, optical storage media, flash memory devices, and/or other machine-readable media. In other embodiments, any appropriate type of storage device may be used. Although only one storage device 115 is shown, multiple storage devices and multiple types of storage devices may be present. Further, although the server 102 is drawn to contain the storage device 115, it may be distributed across other servers, such as devices connected to the network 105.

The storage device 115 includes a data mining engine 126, inventory data 128, and triggers 130, all of which may in various embodiments have any number of instances.

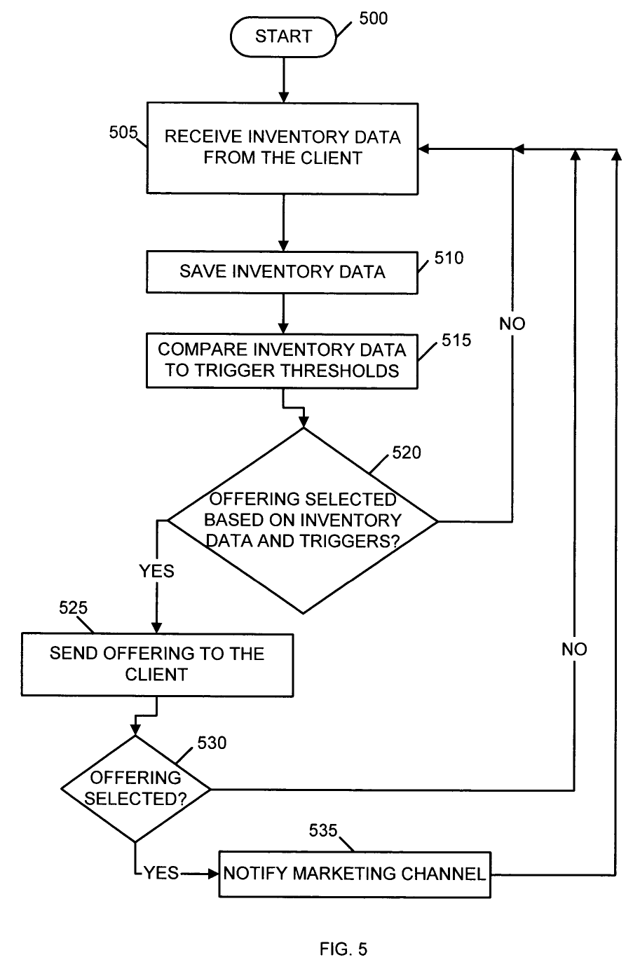

The data mining engine 126 includes instructions capable of executing on the processor 110 or statements capable of being interpreted by instructions executing on the processor 110. The data mining engine 126 receives the inventory data 128 from the client, determines an offering using the inventory data 128 and the triggers 130, and sends the offering to the client 104. Example processing for the data mining engine 126 is further described below with reference to FIG. 5.

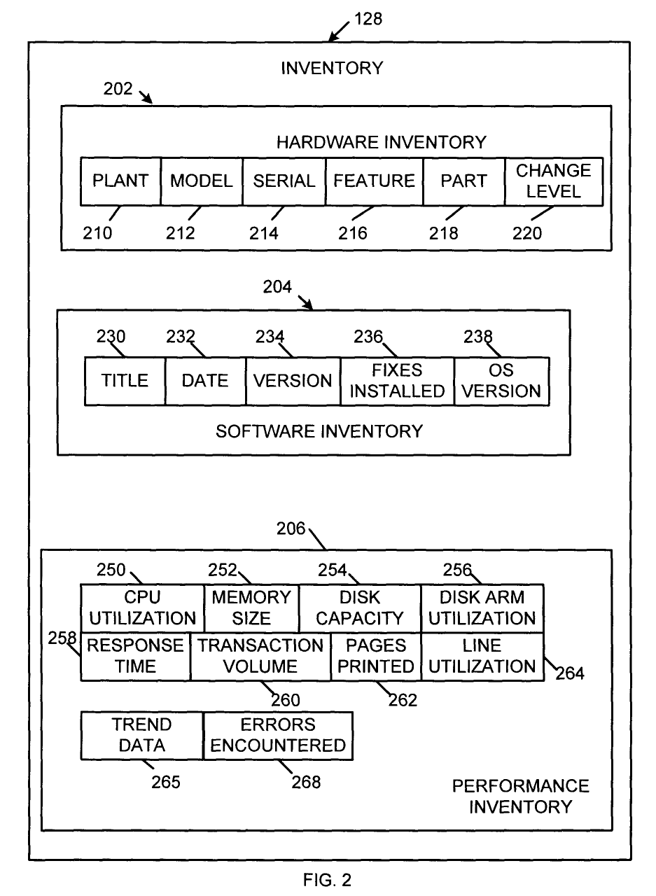

The inventory data 128 may include a hardware inventory, a software inventory, and a performance inventory of the client 104. The inventory data 128 may further include a history of inventories regarding the client 104. In other embodiments, the inventory data 128 may include any appropriate data regarding the client 104. The inventory data 128 is further described below with reference to FIG. 2.

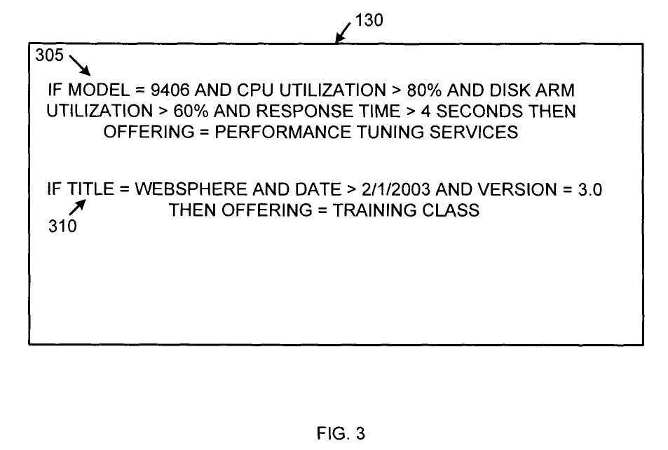

In an embodiment, the triggers 130 include threshold data that the mining engine 126 may compare with the inventory data 128 in order to determine whether the data mining engine 126 should recommend an offering to the client 104. The triggers 130 may further include a condition or conditions that the data mining engine 126 may use when comparing the inventory data 128 to the threshold data and may also include the resulting offering for use when the condition or conditions are met. In other embodiments, the triggers 130 include logic instructions that may be executed on the processor 110 or statements that may be interpreted by instructions, e.g. the data mining engine 126, executing on the processor 110. Although the triggers 130 are drawn as being separate from the mining engine 126, in another embodiment they may be packaged together. The triggers 130 are further described below with reference to FIG. 3.

Although the data mining engine 126, the inventory data 128, and the triggers 130 are all illustrated as being contained within the storage device 115 in the server 102, in other embodiments some or all of them may be in different storage devices or on different servers and accessed remotely, e.g., via the network 105.

The input device 120 may be a keyboard, mouse or other pointing device, trackball, touchpad, touchscreen, keypad, microphone, voice recognition device, or any other appropriate mechanism for the user to input data to the server 102 and/or to manipulate the user interfaces, if any, of the server 102. Although only one input device 120 is shown, in another embodiment any number, including zero, and type of input devices may be present.

The output device 122 is that part of the server 102 that presents output to the user. The output device 122 may be a cathode-ray tube (CRT) based video display well known in the art of computer hardware. But, in other embodiments the output device 122 may be replaced with a liquid crystal display (LCD) based or gas, plasma-based, flat-panel display. In still other embodiments, any appropriate display device may be used. In other embodiments, a speaker or a printer may be used. In other embodiments any appropriate output device may be used. Although only one output device 122 is shown, in other embodiments, any number of output devices of different types or of the same type may be present. In another embodiment, the output device 122 is not present.

The bus 125 may represent one or more busses, e.g., PCI (Peripheral Component Interconnect), ISA (Industry Standard Architecture), X-Bus, EISA (Extended Industry Standard Architecture), or any other appropriate bus and/or bridge (also called a bus controller).

The server 102 may be implemented via an electronic device using any suitable hardware and/or software. Examples of electronic devices are personal computers, portable computers, laptop or notebook computers, PDAs (Personal Digital Assistants), pocket computers, telephones, pagers, automobiles, teleconferencing systems, appliances, midrange computers, and mainframe computers, but in other embodiments any appropriate electronic device may be used. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

The client 104 may be an electronic device implemented via any suitable hardware and/or software that sends requests to and receives responses from the server 102 via the network 105. The client 104 may include a storage device 145, a processor 146, and an output device 147 analogous to those already described above with reference to the server 102. The client 104 may further contain other components in various embodiments, such as an unillustrated input device, a bus, or any other appropriate components. The storage device 145 includes a notification service 150 that collects inventory data regarding the hardware, software, and/or performance of the client 104 and sends the data to the server 102 via the network 105, as further described below with reference to FIG. 5. In an embodiment, the notification service 150 may be part of a system that collects data in order to provide reports regarding the performance and/or configuration of the client 104, but in other embodiments the notification service 150 may be a stand-alone service or part of any appropriate application.

In an embodiment, the notification service 150 collects and sends the inventory data to the server 102 at periodic intervals, e.g., hourly, daily, weekly, monthly, or any other appropriate interval. In other embodiments, the notification service 150 collects and sends the inventory data upon the occurrence of an event, e.g., when requested, when an error is encountered, when a performance problem is encountered, when a new hardware or software component is installed, when a fix is installed, or any other appropriate event. In another embodiment, the notification service 150 may send the inventory data at both at periodic intervals and upon the occurrence of an event.

The marketing channel 103 receives a message or other notification from the client 104 indicating that the client 104 or a user of the client 104 desires to be contacted regarding an offering, desires more information, or desires to order an offering. In various embodiments, the marketing channel 103 may be a wireless or land-line telephone, a computer, a pager, or any other appropriate electronic device. The processing of the marketing channel 103 is farther described below with reference to FIG. 5.

The network 105 may be any suitable network or combination of networks and may support any appropriate protocol suitable for communication of data and/or code to/from the server 102, the marketing channel 103, and the client 104. In various embodiments, the network 105 may represent a storage device or a combination of storage devices, either connected directly or indirectly to the server 102. In an embodiment, the network 105 may support Infiniband. In another embodiment, the network 105 may support wireless communications. In another embodiment, the network 105 may support hard-wired communications, such as a telephone line or cable. In another embodiment, the network 105 may support the Ethernet IEEE (Institute of Electrical and Electronics Engineers) 802.3x specification. In another embodiment, the network 105 may be the Internet and may support IP (Internet Protocol). In another embodiment, the network 105 may be a local area network (LAN) or a wide area network (WAN). In another embodiment, the network 105 may be a hotspot service provider network. In another embodiment, the network 105 may be an intranet. In another embodiment, the network 105 may be a GPRS (General Packet Radio Service) network. In another embodiment, the network 105 may be any appropriate cellular data network or cell-based radio network technology. In another embodiment, the network 105 may be an IEEE 802.11B wireless network. In still another embodiment, the network 105 may be any suitable network or combination of networks. Although one network 105 is shown, in other embodiments any number of networks (of the same or different types) may be present.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the server 102 and/or the client 104, and that, when read and executed by one or more processors in the server 102 and/or the client 104, cause the server 102 and/or the client 104 to perform the steps necessary to execute steps or elements embodying the various aspects of an embodiment of the invention.

Moreover, while embodiments of the invention have and hereinafter will be described in the context of fully functioning electronic devices, the various embodiments of the invention are capable of being distributed as a program product in a variety of forms, and the invention applies equally regardless of the particular type of signal-bearing medium used to actually carry out the distribution. The programs defining the functions of this embodiment may be delivered to the server 102, the marketing channel 103, and/or the client 104 via a variety of signal-bearing media, which include, but are not limited to:
(1) information permanently stored on a non-rewriteable storage medium, e.g., a read-only memory device attached to or within a server, such as a CD-ROM readable by a CD-ROM drive;
(2) alterable information stored on a rewriteable storage medium, e.g., a hard disk drive or diskette; or
(3) information conveyed to a server by a communications medium, such as through a computer or a telephone network, e.g., the network 105, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example inventory data structure 128, according to an embodiment of the invention. The inventory 128 includes a hardware inventory record 202, a software inventory record 204, and a performance inventory record 206. In other embodiments, some of the hardware inventory record 202, the software inventory record 204, and the performance inventory record 206 may not be present. In other embodiments, other inventories may be present representing any appropriate data regarding the client 104.

The hardware inventory record 202 includes a plant field 210, a model field 212, a serial number field 214, a feature field 216, a part number field 218, and a change level field 220, although in other embodiments more or fewer fields may be present. The hardware inventory record 202 is associated with a hardware component of the client 104. For example, in various embodiments, the hardware component may the client 104 itself, the storage device 145, the processor 146, the output device 147, a bus card, or any other appropriate hardware component that can be discretely identified. Although only one hardware inventory record 202 is shown, in other embodiments, any number of records may be present corresponding to any number of respective hardware components installed on the client 104. In an embodiment, a hardware component may have multiple records 202 that form a history of the component as it has been updated or changed over time.

The plant field 210 specifies the manufacturing plant where the hardware component associated with the record 202 was manufactured. The model field 212 specifies the model of the hardware component associated with the record 202. The serial number field 214 specifies the serial number of the hardware component associated with the record 202. The feature field 216 specifies a feature code of the hardware component associated with the record 202. The part number field 218 specifies a part number of the hardware component associated with the record 202. The change level 220 specifies a version, release, and/or level of the hardware component associated with the record 202.

The software inventory record 204 includes a title field 230, a date field 232, a version field 234, a fixes installed field 236, and an operating system version field 238. The fields shown are exemplary only, and in other embodiments more or fewer fields may be present in the software inventory record 204. The software inventory record 204 is associated with a software component installed at the client 104. For example, in various embodiments, a software component may be a browser, database application, accounting system, or any other appropriate software. Although only one software inventory record 204 is shown, in other embodiments, any number of records may be present corresponding to any number of respective software components installed on the client 104. In an embodiment, a software component may have multiple records 204 that form a history of the software component as it has been updated or changed over time.

The title field 230 specifies the title or name or otherwise identifies the software associated with the record 204. The date field 232 specifies the date that the software associated with the record 204 was installed on the client 104. The version field 234 specifies the release, version, and/or level of the software associated with the record 204. The fixes installed field 236 specifies what fixes, if any, are installed at the client 104 for the software associated with the record 204. The operating system version field 238 specifies the operating system that is running the software associated with the record 204.

The performance inventory record 206 describes a record of the performance of the client 104 and/or of a component of the client 104. The performance inventory record 206 includes a CPU (Central Processing Unit) utilization field 250, a memory size field 252, a disk capacity field 254, a disk arm utilization field 256, a response time field 258, a transaction volume field 260, a pages printed field 262, a line utilization field 264, a trend data field 265, and an errors encountered field 268. The fields shown are exemplary only, and in other embodiments more or fewer fields may be present in the performance inventory record 206. In an embodiment, multiple records 206 may be present that form a performance history of the client 104 or a component of the client 104, as the performance has changed over time.

The CPU utilization field 250 specifies the percentage of time that the processor 146 spends executing instructions. The memory size field 252 specifies the memory capacity and/or memory available in the client 104. The disk capacity field 254 specifies amount of available storage in the storage device 145. The disk arm utilization field 256 specifies data regarding the utilization of a disk arm or arms within the storage device 145. The response time field 258 specifies data regarding the amount of time taken by an application or applications at the client 104 to perform a transaction. The transaction volume field 260 specifies the number of transactions performed by an application or applications running on the client 104. The pages printed field 262 specifies the number of pages printed by a printer or printers associated with the client 104. The line utilization field 264 specifies the utilization of transfers between the client 104 and the network 105. The trend data field 265 depicts the rate of growth or consumption of a resource at the client 104. In an embodiment, the trend data field 265 includes an estimated time period, such as days, weeks, or months, until the resource is constrained. The errors encountered field 268 specifies errors, faults, or problems encountered by software and/or hardware associated with the client 104.

FIG. 3 depicts a block diagram of example triggers 130, according to an embodiment of the invention. In an embodiment, the triggers 130 include rules, such as rules 305 and 310. In various embodiments, the data mining engine 126 may execute the rules, interpret the rules, or cause the rules to be executed or interpreted. The rules include conditions that specify a comparison of selected fields in the inventory data 128 to thresholds. A condition may specify that a specified field needs to be greater than, equal to, less than, greater than or equal to, or less than or equal to a specified threshold in order for a specified offering to be recommended. In other embodiments any appropriate condition may be used. When the conditions are met, the data mining engine 126 recommends a specified offering.

For example, rule 305 recites: “If model=9406 and CPU utilization>80% and disk arm utilization>60% and response time>4 seconds then offering=performance tuning services.” Thus, when the data mining engine 126 executes or interprets rule 305, the data mining engine 126 determines whether the model field 212 specifies a model of 9406, the CPU utilization field 250 specifies a value greater than 80%, the disk arm utilization field 256 specifies a value greater than 60%, and the response time field 258 specifies a value greater than 4 seconds. If that determination is true, then the data mining engine 126 creates an offering of performance tuning services and sends the offering to the client 104, as further described below with reference to FIG. 5.

As another example, rule 310 recites: “If title=Websphere and date>2/1/2003 and version=3.0 then offering=training class.” Thus, when the data mining engine 126 executes or interprets rule 310, the data mining engine 126 determines whether the title field 230 specifies Websphere, the date field 232 specifies a date later than Feb. 1, 2003, and the version field 234 specifies a version of 3.0. If that determination is true, then the data mining engine 126 creates an offering of a training class appropriate for the Websphere product version 3.0 and sends the offering to the client 104, as further described below with reference to FIG. 5.

The fields, conditions, thresholds, and offerings specified in the rules 305 and 310 of the triggers 130 are exemplary only, and in another embodiment any appropriate fields in the inventory data 128 may be used and any appropriate thresholds, conditions, and offerings may be used. Further, the triggers 130 may use the saved history of the inventory data 128. For example, a rule may specify the analysis of a trend in the history, such as determining whether the performance of the client 104 or the available storage in the client 104 is increasing or decreasing over time. But, in other embodiments, the rules in the triggers 130 may make any appropriate use of the saved history of the inventory data 128.

Although the offerings illustrated in FIG. 3 are performance tuning services and a training class, in various other embodiments, the offerings may be new hardware or software, new versions or releases of hardware or software, fixes to hardware or software, documentation, or any other appropriate goods or services.

Although FIG. 3 depicts the triggers 130 as rules to be executed or interpreted by the data mining engine 126, in another embodiment the triggers 130 may be represented as a data structure or table to be accessed by the data mining engine 126.

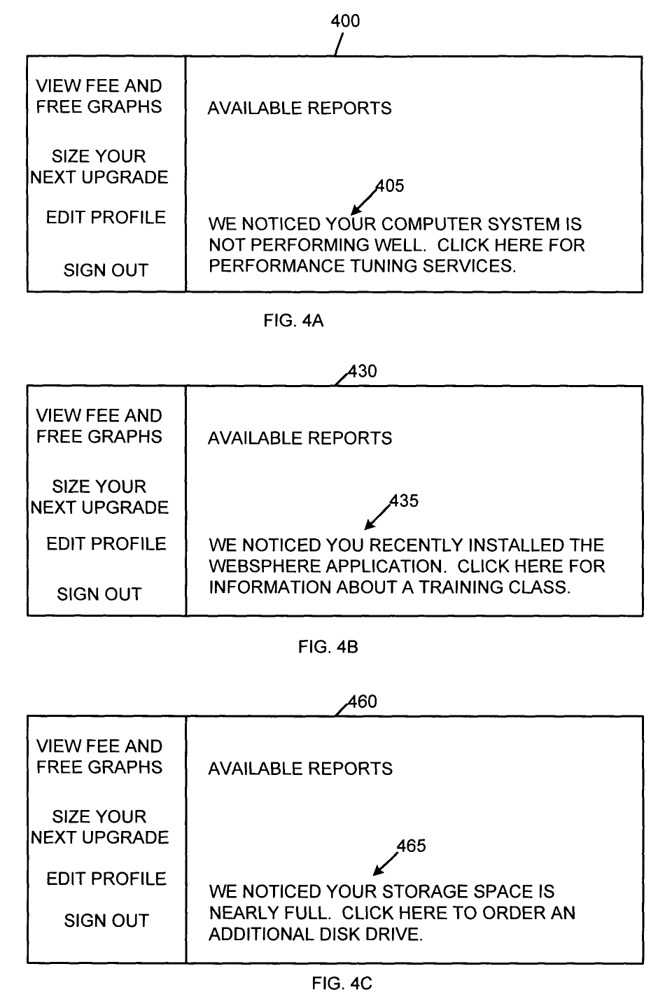

FIGS. 4A, 4B, and 4C depict pictorial representations of respective example user interfaces 400, 430, and 460 presented at the client 104, according to various embodiments of the invention. The notification service 150 receives an offering from the mining engine 126 and presents the respective example user interfaces 400, 430, and 460 via the output device 147. In another embodiment, a program separate from the notification service 150, such as a browser or any other appropriate function, may receive and/or present the example user interfaces 400, 430, and 460 and may respond to user selections and inputs from the respective user interfaces.

The user interface 400 includes an offering 405, which states: “We noticed your computer system is not performing well. Click here for performance tuning services.” If the user selects the offering 405, the notification service 150 sends a notification to the marketing channel 103. In various embodiments, the notification may be a request for a marketing person to contact the user of the client 104, may be a request to receive a mailing of information, may be a request to schedule the tuning services, or may be a request to receive online or downloaded information regarding the offering. In another embodiment, the notification may be a request to receive further information regarding why the offering is being made, e.g., the further information may include selected data from the inventory data 128 that explains the reasoning for the need for performance tuning services.

The user interface 430 includes an offering 435, which states: “We noticed you recently installed the Websphere application. Click here for information about a training class.” If the user selects the offering 435, the notification service 150 sends a notification to the marketing channel 103. In various embodiments, the notification may be a request for a marketing person to contact the user of the client 104, may be a request to receive a mailing of information, may be a request for online scheduling of the training class, or may be a request to receive online or downloaded information regarding the offering.

The user interface 460 includes an offering 465, which states: “We noticed your storage space is nearly full. Click here to order an additional disk drive.” If the user selects the offering 465, the notification service 150 sends a notification to the marketing channel 103. In various embodiments, the notification may be a request for a marketing person to contact the user of the client 104, may be a request to receive a mailing of information, may be a request for online ordering of the offering, or may be a request to receive online or downloaded information regarding the offering. In another embodiment, the notification may be a request to receive further information regarding why the offering is being made, e.g., the further information may include collected data regarding the allocation and usage of the various storage spaces associated with the client 104.

Although the offerings 405, 435, and 465 are illustrated as being part of respective user interfaces 400, 430, and 460 where the user of the client 104 may also view reports in addition to receiving notification of the offering, in another embodiment the offerings 405, 435, and 465 may be separate from other information. Although the offerings illustrated in FIGS. 4A, 4B, and 4C are performance tuning services, a training class, and an additional disk drive, respectively, in various other embodiments the offerings may be any appropriate new hardware or software, new versions or releases of hardware or software, fixes to hardware or software, documentation, or any other appropriate goods or services.

FIG. 5 depicts a flowchart of example processing, according to an embodiment of the invention. Control begins at block 500. Control then continues to block 505 where the server 102 receives inventory data from the notification service 150 at the client 104. Control then continues to block 510 where the server 102 stores the received inventory data in the inventory data 128. In an embodiment, the server 102 may store multiple records over time of inventory data to form a history of the inventory data.

Control then continues to block 515 where the data mining engine 126 compares selected fields in the inventory data 128 to the thresholds using the triggers 130, as previously described above with reference to FIGS. 2 and 3. In an embodiment, the mining engine 126 may compare multiple records that form a history of the inventory data 128 in order, for example, to determine a trend or change in the inventory data 128.

Control then continues to block 520 where the mining engine 126 determines whether an offering is appropriate based on the comparison of block 515. If the determination at block 520 is false, then control returns to block 505, as previously described above.

If the determination at bock 520 is true, then control continues to block 525 where the mining engine 126 sends the determined offering to the client 104, which recommends the offering to the client 104. The mining engine 126 further sends to the client an identification of the marketing channel 103 that is to be notified if the user selects the offering. Control then continues to block 530 where the notification service 150 determines whether the user has selected an offering. If the determination at block 530 is false, then control returns to bock 505, as previously described above.

If the determination at block 530 is true, then control continues to block 535 where the notification service 150 notifies the identified marketing channel 103 of the user's selection. In various embodiments, the marketing channel 103 may contact the user, may provide additional information, or may allow the user to order goods and/or services online, as previously described above with reference to FIGS. 4A, 4B, and 4C. Control then returns to block 505 as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

1. A method comprising:
recommending an offering based on data received from a client and a threshold.

2. The method of claim 1, wherein the recommending further comprises:
comparing the data to the threshold; and
when the comparing satisfies a condition, sending the offering to the client.

3. The method of claim 1, wherein the data comprises a hardware inventory of the client.

4. The method of claim 1, wherein the data comprises a software inventory of the client.

5. The method of claim 1, wherein the data comprises a performance inventory of the client.

6. The method of claim 1, wherein the data comprises a trend at the client.

7. An apparatus comprising:
means for receiving an inventory from a client;
means for selecting an offering based on a plurality of fields in the inventory and a plurality of corresponding thresholds; and
means for sending the offering to the client.

8. The apparatus of claim 7, further comprising:
means for saving a history of the inventory as the inventory changes over time.

9. The apparatus of claim 8, wherein the means for selecting further comprises:
means for comparing a plurality of records in the history.

10. The apparatus of claim 7, wherein the offering comprises an offer for a service.

11. The apparatus of claim 7, wherein the offering comprises an offer for hardware.

12. A signal-bearing medium encoded with instructions, wherein the instructions when executed comprise:
receiving inventory data from a client, wherein the inventory data comprises a plurality of fields;
comparing a subset of the plurality of fields to a plurality of thresholds via a plurality of rules, wherein the plurality of rules specify the subset, the plurality of thresholds, and a plurality of offerings;
selecting one of the plurality of offerings in response to the comparing; and
sending the one of the plurality of offerings to the client.

13. The signal-bearing medium of claim 12, further comprising:
sending an identification of a marketing channel to the client, wherein the marketing channel is to be notified if the offering is selected.

14. The signal-bearing medium of claim 12, wherein the receiving further comprises:
periodically receiving updates to the inventory data from the client.

15. The signal-bearing medium of claim 12, wherein the receiving further comprises:
receiving updates of the inventory data after the occurrence of an event at the client.

16. The signal-bearing medium of claim 15, wherein the event is selected from a group consisting of: installation of hardware at the client, installation of software at the client, and detection of a performance problem at the client.

17. A server comprising:
a processor; and
a storage device encoded with instructions, wherein the instructions when executed on the processor comprise:
receiving inventory data from a client, wherein the inventory data comprises a plurality of fields,
comparing a subset of the plurality of fields to a plurality of thresholds via a plurality of conditions, and
when the plurality of conditions are met, sending an associated offering and an identification of a marketing channel to the client.

18. The server of claim 17, wherein the subset, the plurality of the thresholds, and the plurality of conditions are specified by a rule that is interpreted by the instructions.

19. The server of claim 17, wherein the subset, the plurality of the thresholds, and the plurality of conditions are specified by a table that is accessed by the instructions.

20. The server of claim 17, wherein marketing channel is to be notified when the offering is selected at the client.

21. The server of claim 17, wherein the receiving further comprises:
periodically receiving updates of the inventory data from the client.
